(19) United States
(12) Patent Application Publication
(10) Pub. No.: US 2015/0215838 A1
(43) Pub. Date: Jul. 30, 2015

(54) METHOD AND APPARATUS FOR MOBILITY CONTROL IN HETEROGENOUS NETWORK

(71) Applicants: Haitao Li, Beijing (CN); Yang Liu, Beijing (CN); Yixue Lei, Beijing (CN); Kodo Shu, Shanghai (CN)

(72) Inventors: Haitao Li, Beijing (CN); Yang Liu, Beijing (CN); Yixue Lei, Beijing (CN); Kodo Shu, Shanghai (CN)

(73) Assignee: Nokia Corporation

(21) Appl. No.: 14/423,335

(22) PCT Filed: Sep. 12, 2012
(86) PCT No.: PCT/CN2012/081300

§ 371 Date: Feb. 23, 2015

(51) Int. Cl. H04W 36/30; H04W 36/00; H04W 12/04

(52) U.S. Cl. CPC H04W 36/30; H04W 12/04; H04W 36/0038; H04W 84/045

(57) ABSTRACT

Methods, corresponding apparatuses, and computer program products for mobility control in a heterogeneous network are provided. The method comprises sending, by a source local area base station (e.g., a source access point), a handover request for handing over a user equipment to a target local area base station (e.g., a target access point), wherein the source and target local area base stations are connected with a same wide area base station and the user equipment is connected with the same wide area base station via the source local area base station. The method also comprises handing over, based on a handover request acknowledgement from the target local area base station, the user equipment to the target local area base station for continuing with at least one of an ongoing local area service and an ongoing wide area service without changing security keys of the same wide area base station. With the claimed inventions, the handover latency and service continuity during the inter-AP mobility would be efficiently improved in a secure manner.

### FIELD OF THE INVENTION

Embodiments of the present invention generally relate to wireless communication techniques including the 3GPP (the 3rd Generation Partnership Project) LTE (Long Term Evolution) technique. More particularly, embodiments of the present invention relate to methods, corresponding apparatuses, and computer program products for mobility control in a heterogeneous network.

### BACKGROUND OF THE INVENTION

Various abbreviations that appear in the specification and/or in the drawing figures are defined as below:

ACK Acknowledgement

AP Access Point

AS Access Stratum

BS Base Station

CN Core Network

CA Carrier Aggregation

DRB Data Radio Bearer

eLAN enhanced Local Area Network

eNB evolved Node B

EPS Enhanced Packet System

EPC Enhanced Packet Core

E-RAB EPS Radio Access Bearer

EUTRAN Evolved Universal Terrestrial Radio Access Network

GPRS General Packet Radio Service

GW Gateway

HLR Home Location Register

HSS Home Subscriber Server

IP Internet Protocol

LAN Local Area Network

MME Mobility Management Entity

MSC Mobile Switching Centre

NAS Non Access Stratum

OAM Operations, Administrations and Maintenance

PCI Physical Cell Identifier

PDN Packet Data Network

PDCP Packet Data Convergence Protocol

QoS Quality of Service

RNC Radio Network Controller

RRC Radio Resource Control

RRM Radio Resource Management

SN Support Node

SRB Signaling Radio Bearer

UE User Equipment

VLR Visitor Location Register

WAN Wide Area Network

The following description of background art may include insights, discoveries, understandings or disclosures, or associations together with disclosures not known to the relevant art prior to the present invention but provided by the present invention. Some such contributions of the present invention may be specifically pointed out below, while other such contributions of the present invention will be apparent from their context.

Along with the development of an LTE system, high-speed data service is one of the most important requirements. Especially for LANs, higher data rate may be expected from a user's perspective. How to provide local services with high speed data rate has become a hot topic in 3GPP.

### SUMMARY OF THE INVENTION

The following presents a simplified summary of the present invention in order to provide a basic understanding of some aspects of the present invention. It should be noted that this summary is not an extensive overview of the present invention and that it is not intended to identify key/critical elements of the present invention or to delineate the scope of the present invention. Its sole purpose is to present some concepts of the present invention in a simplified form as a prelude to the more detailed description that is presented later.

One embodiment of the present invention provides a method. The method comprises sending, by a source local area BS, a handover request for handing over a UE to a target local area BS, wherein the source and target local area BSs are connected with a same wide area BS and the UE is connected with the same wide area BS via the source local area BS.

The method also comprises handing over, based on a handover request ACK from the target local area BS, the UE to the target local area BS for continuing with at least one of an ongoing local area service and an ongoing wide area service without changing security keys of the same wide area BS.

In one embodiment, the method further comprises receiving, prior to the sending a handover request, a measurement report from the UE and determining, based on the measurement report, whether the target local area BS is connected with the same wide area BS.

In another embodiment, the determining comprises at least one of checking availability of an X2 interface between the source local area BS and the target local area BS and checking target cell information included in the measurement report.

In an additional embodiment, the ongoing local area service is carried by at least one local area DRB and the ongoing wide area service is carried by at least one offloaded EPS DRB.

In yet another embodiment, the handover request at least includes information regarding QoS of the at least one local area DRB, QoS of the at least one offloaded EPS DRB, and at least one local security key to be used by the target local area BS.

In a further embodiment, the handover request ACK at least includes configuration information of the at least one local area DRB which has been accepted by the target local area BS and radio resource configuration information. In an additional embodiment, the handover request is used to request the target local area BS for admission of one or more of the at least one local service DRB and the at least one offloaded EPS DRB. In one embodiment, the handing over to the target local area BS comprises handing over to the target local area BS via an X2 interface between the source local area BS and the target local area BS.

In one embodiment, the source and target local area BSs are LTE based APs and the same wide area BS is an eNB.

Another embodiment of the present invention provides a method. The method comprises receiving, at a target local area BS, a handover request from a source local area BS for handing over a UE to continue with at least one of an ongoing local area service and an ongoing wide area service, wherein the source and target local area BSs are connected with a same wide area BS and the UE is connected with the same wide area BS via the source local area BS. The method further comprises performing admission control with respect to at least one of the ongoing local area service and the ongoing wide area service. The method additionally comprises sending, based on a result of the admission control, a handover request ACK to the source local area BS for handing over the UE to the target local area BS to continue with the at least one of the ongoing local area service and the ongoing wide area service without changing security keys of the same wide area BS.

In one embodiment, the ongoing local area service is carried by at least one local area DRB and the ongoing wide area service is carried by at least one offloaded EPS DRB.

In another embodiment, the handover request at least includes information regarding QoS of the at least one local area DRB, QoS of the at least one offloaded EPS DRB, and at least one local security key to be used by the target local area BS.

In yet another embodiment, the handover request ACK at least includes configuration information of the at least one local area DRB which has been accepted by the target local area BS and radio resource configuration information.

In one embodiment, the method further comprises at least reporting to the same wide area BS at least one updated offloaded EPS DRB as a result of admission control with respect to at least one ongoing wide area service. The method additionally comprises forwarding to the UE having been connected with the target local area BS by the handover an updated configuration of at least one updated offloaded EPS DRB from the same wide area BS. Furthermore, the method comprises forwarding to the same wide area BS a reconfiguration complete message for the updated configuration from the UE to hand over the at least one updated offloaded EPS DRB to the target local area BS.

In another embodiment, the handover between the source local area BS and the target local area BS is performed via an X2 interface and communication of the source and target local area BSs with the same wide area BS is performed via an S1 interface. In a further embodiment, the source and target local area BSs are LTE based APs and the same wide area BS is an eNB.

One embodiment of the present invention provides an apparatus. The apparatus comprises means for sending, by a source local area BS, a handover request for handing over a UE to a target local area BS, wherein the source and target local area BSs are connected with a same wide area BS and the UE is connected with the same wide area BS via the source local area BS. The apparatus also comprises means for handing over, based on a handover request ACK from the target local area BS, the UE to the target local area BS for continuing with at least one of an ongoing local area service and an ongoing wide area service without changing security keys of the same wide area BS.

Another embodiment of the present invention provides an apparatus. The apparatus comprises means for receiving, at a target local area BS, a handover request from a source local area BS for handing over a UE to continue with at least one of an ongoing local area service and an ongoing wide area service, wherein the source and target local area BSs are connected with a same wide area BS and the UE is connected with the same wide area BS via the source local area BS. The apparatus also comprises means for performing admission control with respect to at least one of the ongoing local area service and the ongoing wide area service. The apparatus additionally comprises means for sending, based on a result of the admission control, a handover request ACK to the source local area BS for handing over the UE to the target local area BS to continue with the at least one of the ongoing local area service and the ongoing wide area service without changing security keys of the same wide area BS.

A further embodiment of the present invention provides an apparatus. The apparatus comprises at least one processor and at least one memory including computer program instructions. The at least one memory and computer program instructions are configured to, with the at least one processor, cause the apparatus at least to send, by a source local area BS, a handover request for handing over a UE to a target local area BS, wherein the source and target local area BSs are connected with a same wide area BS and the UE is connected with the same wide area BS via the source local area BS. The at least one memory and computer program instructions are also configured to, with the at least one processor, cause the apparatus at least to hand over, based on a handover request ACK from the target local area BS, the UE to the target local area BS for continuing with at least one of an ongoing local area service and an ongoing wide area service without changing security keys of the same wide area BS.

Another embodiment of the present invention provides an apparatus. The apparatus comprises at least one processor and at least one memory including computer program instructions. The at least one memory and computer program instructions are configured to, with the at least one processor, cause the apparatus at least to receive, at a target local area BS, a handover request from a source local area BS for handing over a UE to continue with at least one of an ongoing local area service and an ongoing wide area service, wherein the source and target local area BSs are connected with a same wide area BS and the UE is connected with the same wide area BS via the source local area BS. The at least one memory and computer program instructions are also configured to, with the at least one processor, cause the apparatus at least to perform admission control with respect to at least one of the ongoing local area service and the ongoing wide area service. The at least one memory and computer program instructions are additionally configured to, with the at least one processor, cause the apparatus at least to send, based on a result of the admission control, a handover request ACK to the source local area BS for handing over the UE to the target local area BS to continue with the at least one of the ongoing local area service and the ongoing wide area service without changing security keys of the same wide area BS.

One embodiment of the present invention provides a computer program product, comprising at least one computer readable storage medium having a computer readable program code portion stored thereon. The computer readable program code portion comprises program code instructions for sending, by a source local area BS, a handover request for handing over a UE to a target local area BS, wherein the source and target local area BSs are connected with a same wide area BS and the UE is connected with the same wide area BS via the source local area BS. The computer readable program code portion also comprises program code instructions for handing over, based on a handover request ACK from the target local area BS, the UE to the target local area BS for continuing with at least one of an ongoing local area service and an ongoing wide area service without changing security keys of the same wide area BS.

Another embodiment of the present invention provides a computer program product, comprising at least one computer readable storage medium having a computer readable program code portion stored thereon. The computer readable program code portion comprises program code instructions for receiving, at a target local area BS, a handover request from a source local area BS for handing over a UE to continue with at least one of an ongoing local area service and an ongoing wide area service, wherein the source and target local area BSs are connected with a same wide area BS and the UE is connected with the same wide area BS via the source local area BS. The computer readable program code portion also comprises program code instructions for performing admission control with respect to at least one of the ongoing local area service and the ongoing wide area service. The computer readable program code portion additionally comprises program code instructions for sending, based on a result of the admission control, a handover request ACK to the source local area BS for handing over the UE to the target local area BS to continue with the at least one of the ongoing local area service and the ongoing wide area service without changing security keys of the same wide area BS.

According to the embodiments of the present invention as presented above, for local services, inter-AP mobility can be based on the X2 interface without eNB involvement and thus better service continuity for local services can be achieved. Moreover, keeping EPS security keys unchanged during the inter-AP handover can reduce data interruptions for EPS services due to the absence of reestablishment of the EPS PDCP entities. Additionally, the embodiments of the present invention enable good decoupling and separation between local security and EPS security mechanisms, and thereby enable flexible deployment of the LTE-Hi.

### BRIEF DESCRIPTION OF THE DRAWINGS

The embodiments of the present invention that are presented in the sense of examples and their advantages are explained in greater detail below with reference to the accompanying drawings, in which:

FIG. 1 illustrates an exemplary heterogeneous network including an LTE-LAN network and a legacy LTE or EPS network;

FIG. 2 schematically illustrates a vertical C-plane protocol stack for the heterogeneous network as illustrated in FIG. 1;

FIG. 3 schematically illustrates an inter-AP mobility scenario under the same associated eNB according to an embodiment of the present invention;

FIG. 4 is a flow chart schematically illustrating a method for mobility control in a heterogeneous network from a perspective of a source local area BS (e.g., a source AP) according to an embodiment of the present invention;

FIG. 5 is a flow chart schematically illustrating a method for mobility control in a heterogeneous network from a perspective of a target local area BS (e.g., a target AP) according to an embodiment of the present invention;

FIG. 6 is a signaling flow for a method of mobility control in a heterogeneous network according to another embodiment of the present invention; and

FIG. 7 is a simplified schematic block diagram illustrating apparatuses according to embodiments of the present invention.

### DETAILED DESCRIPTION OF EMBODIMENTS

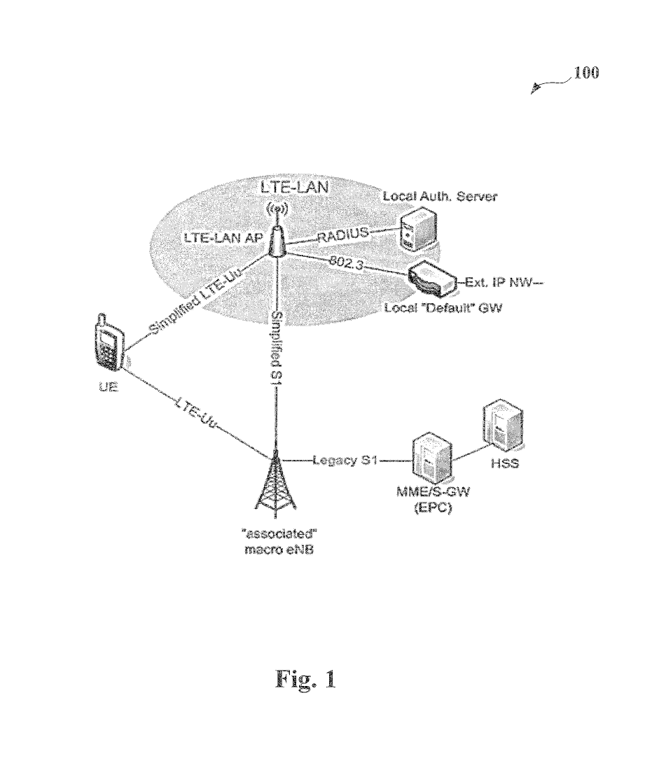

An LTE-LAN (also referred to as LTE-Hi) technique is a heterogeneous network technique that can be used in a network consisting of an EPS network comprising macro/micro/pico BSs and a LAN comprising wireless APs. In such a heterogeneous network, a UE may have EPS and LTE-Hi connectivity separately or concurrently. In this manner, the LTE-Hi may provide high performance services for wireless communication users with relatively low costs. For example, the UE may have EPS bearer, offloaded EPS bearer and LTE-Hi bearer services. For a better understanding of embodiments of the present invention, below is an introduction regarding this heterogeneous network with reference to FIG. 1.

FIG. 1 illustrates an exemplary heterogeneous network 100 including an

LTE-LAN, in which exemplary network entities and interfaces between these entities are illustrated and embodiments of the present application can be practiced. As shown in FIG. 1, the LTE-LAN applies a new LTE-like radio interface as a “simplified LTE-Uu” interface between the UE and LTE-LAN AP. Due to requirement for less CN involvement, the LTE-LAN network according to certain embodiments of the present invention supports a “stand-alone” mode where the LTE-LAN network is working autonomously by providing a basic wireless broadband access with UE traffic routing to a local LAN/IP network directly from an LTE-LAN AP and to the Internet via a default GW of this LAN/IP network. This autonomous “stand-alone” mode operation is useful especially in the case where overlaying macro network service (also termed a wide area service relative to a local area service in the present invention) coverage, e.g., provided by an “associated” macro eNB (also termed a wide area BS in the present invention) as illustrated in FIG. 1, is missing or has poor quality or poor capabilities relative to what the service would need. The local LAN transport network may include an ordinary Ethernet-based LAN, i.e. IEEE 802.3 or any of its modern extensions like Gigabit-Ethernet, as shown in FIG. 1. In general, this stand-alone LTE-LAN operation resembles existing Wi-Fi network solutions except that the radio interface is using said simplified LTE-Uu interface with LTE procedures. The LTE local radio would use LTE physical layer or any of its extensions (e.g., LTE-Advanced) and LTE protocols with possible simplifications compared to a WAN. The LTE-LAN may additionally include new features specifically designed for the local wireless access.

For the autonomous stand-alone mode operation as discussed above, the LTE-LAN network provides means for UE authentication and authorization to use services provided by the LTE-LAN network. This may be implemented by using similar methods as applied in WLAN (IEEE 802.11i) but modified to carry the authentication protocol messages, e.g. EAP encapsulated into LTE Uu RRC messages. In FIG. 1, there is shown an optional local authentication server that may be a RADIUS server or a diameter server like the one used in enterprise networks.

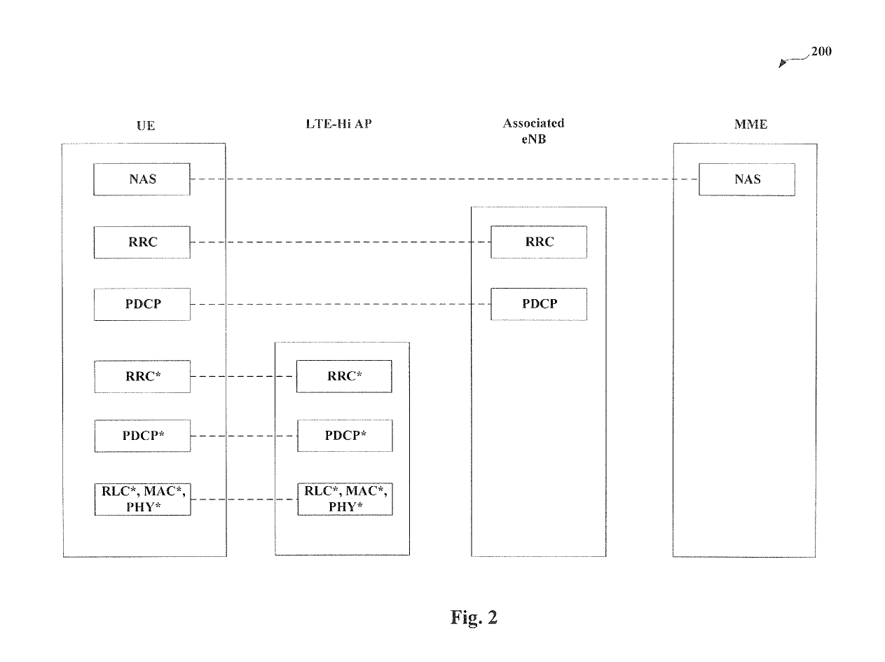

FIG. 2 illustrates a vertical RRC protocol stack for the LTE-Hi as illustrated in FIG. 1. For a concise purpose, some protocol layers that are necessary but not closely relevant to the embodiments of the present invention are omitted in this example protocol stack. In the illustrated protocol stack, communication entities, such as the UE, the LTE-Hi AP, the associated eNB, and the MME may communicate with one another over corresponding peer layers. Also seen in the protocol stack are EPS RRC and PDCP entities at the associated eNB being located on top of local RRC and PDCP entities, i.e., RRC* and PDCP* as identified at the UE and LTE-Hi AP. This protocol arrangement is in a NAS-like style and enables flexible and independent implementation of the local RRC and PDCP functions. Under this protocol arrangement, in order for reusing the current EPS security mechanism, a straightforward approach is to treat the LTE-Hi AP as illustrated in FIGS. 1 and 2 as a subsystem of a macro eNB network (e.g., an EPS network, which is a specific type of a wide area network according to embodiments of the present invention) and inter-AP (a source AP and a target AP) mobility would necessarily involve EPS security key's change based on some parameters (e.g., PCI and a certain frequency) of the target AP. This means that even for UE's inter-AP mobility with a direct X2 interface between APs, the associated eNB is involved in the handover preparation and execution, i.e., an S1-based handover. In particular, the associated eNB would calculate and change the EPS security keys based on the target AP's PCI and DL frequency information, and then issue the handover command to the UE via the source AP.

In the foregoing mobility control, due to changes of the security keys, the EPS PDCP entities at the associated eNB will be reestablished, which may lead to an EPS service interruption and thereby result in a bad user experience. Thus, in order for network operators to provide good service continuity for users or subscribers, a problem on how to efficiently handle the mobility procedures with two RRC functions on local area AP and legacy EPS cells, especially some mobility enhancements on inter-AP handover with offloaded EPS services, needs to be addressed.

To solve the above problem, certain embodiments of the present invention would provide for an efficient way of controlling mobility of UEs in the LTE-Hi-like heterogeneous network such that better service continuity can be achieved for local services. Further, EPS security keys could be maintained intact during the inter-AP handover such that data interruptions for the EPS services can be reduced because there is no need to reestablish the EPS PDCP entities. Additionally, the embodiments of the present invention enable good decoupling and separation between local security and EPS security mechanisms, and thus enable flexible deployment of the LTE-Hi.

Specifically, certain embodiments of the present invention provide optimized solutions to inter-AP mobility in a heterogeneous network. That is, for a UE working in the single radio mode under an LTE-Hi AP (i.e., a source AP) with both local services and offloaded EPS services in operation to perform an inter-AP handover within the same associated eNB, the source AP may directly contact with a target AP, e.g., through an X2 interface, so as to prepare a handover for ongoing local services and offloaded EPS services. Dependent on the outcome of admission control in the target AP, information regarding the accepted local service bearer configuration will be encapsulated by local RRC signaling in a local handover command and sent from the target AP back to the source AP and then delivered to the UE. Information regarding the updated/rejected EPS DRB configurations (e.g., logical channel and RRC configurations) will be reported to the associated eNB by the target AP. It is then the associated eNB that updates the EPS DRB configurations to the UE through the EPS RRC function or connection after the inter-AP handover.

The aforementioned whole process does not involve the change of EPS security keys as long as the associated eNB remains the same during the inter-AP handover. Because there is no change of the EPS security keys and thus no reestablishment of the PDCP entities, the EPS service interruption would be significantly reduced. Further, the lack of eNB involvement during the handover preparation phase can also accelerate or expedite the inter-AP handover procedures and achieve better service continuity for both EPS services and local services thanks to an X2 based handover instead of an S1 based handover.

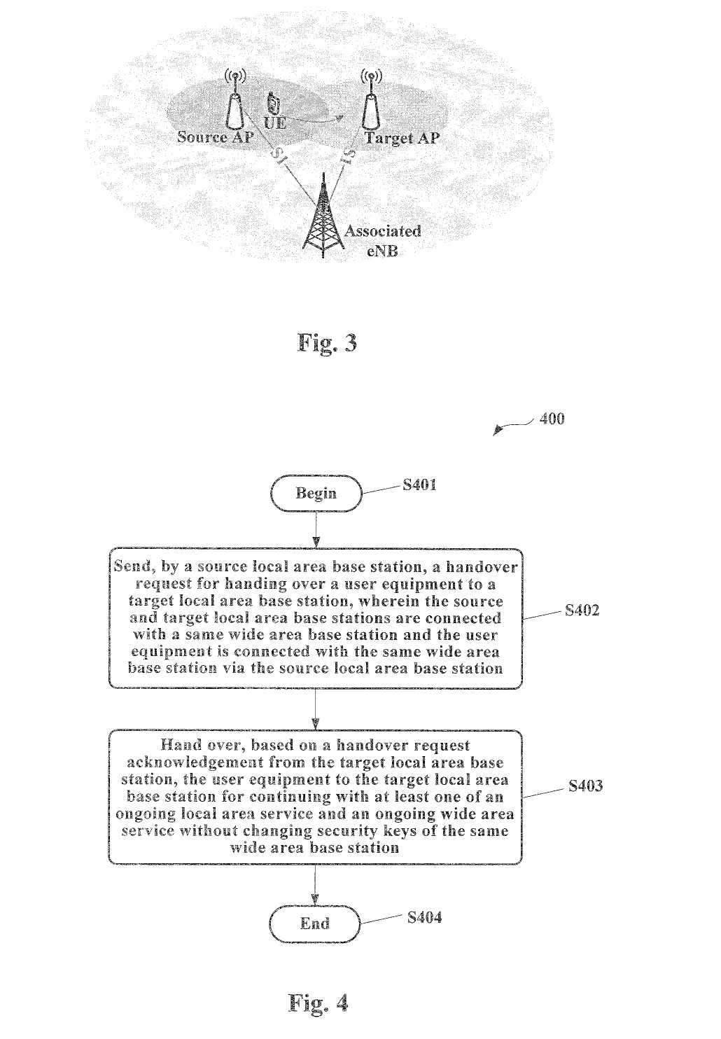

FIG. 3 schematically illustrates an inter-AP mobility scenario under the same associated eNB according to an embodiment of the present invention. As illustrated in FIG. 3, a source AP and a target AP are both connected to the same associated eNB via respective S1 interfaces. Although not shown, it should be noted that the source AP and the target AP are connected with one another via an X2 interface. The UE, as illustrated within the coverage area of the source AP, is operating in a single radio mode. In other words, it may connect with the source AP to have access to the local services and may further connect with the associated eNB via the source AP to have access to the offloaded EPS services. As shown by an arrow, the UE is moving out of the coverage area of the source AP and entering into the coverage area of the target AP, in which case an inter-AP handover may take place.

According to the embodiments of the present invention as briefly discussed as above, with respect to the local services, the target AP may perform admission control for the local bearers and directly instruct the source AP to hand over the UE to the target AP via the X2 interface. In contrast, with respect to the EPS services, the target AP may perform corresponding admission control for the EPS bearers. In case the target AP may update or reject the EPS DRB configurations, it may inform the associated eNB via the illustrated S1 interface of the updated or rejected EPS DRB configurations. Then, the associated eNB ciphers the updated or rejected configurations and relays via the target AP to the UE the updated or rejected configurations. Thereby, the updated EPS DRBs may also be handed over to the target AP. In case the target AP may accept all EPS DRB configurations, these EPS DRBs can be directly handed over to the target AP via the X2 interface, similar to the case for the local bearers.

FIG. 4 is a flow chart schematically illustrating a method 400 for mobility control in a heterogeneous network from a perspective of a source local area BS (e.g., a source AP) according to the embodiments of the present invention. As illustrated in FIG. 4, the method 400 begins at step S401 and proceeds to step S402, at which the method 400 sends, by a source local area BS (e.g., the source AP as shown in FIG. 3), a handover request for handing over a UE to a target local area BS (e.g., the target AP as shown in FIG. 3), wherein the source and target local area BSs are connected with a same wide area BS (e.g, the associated eNB as shown in FIG. 3) and the UE is connected with the same wide area BS via the source local area BS, i.e., the UE is in a single radio mode as mentioned before.

Although not shown, in some embodiments, the method 400 further comprises receiving, prior to the sending a handover request, a measurement report from the UE and determining, based on the measurement report, whether the target local area BS is connected with the same wide area BS. The determining herein can be implemented by at least one of checking availability of an X2 interface between the source local area BS and the target local area BS and checking target cell information included in the measurement report. Further, in some embodiments, the handover request at least includes information regarding QoS of the at least one local area DRB, QoS of the at least one offloaded EPS DRB, and at least one local security key to be used by the target local area BS. The handover request herein can be used to request the target local area BS for admission of one or more of the at least one local service DRB and the at least one offloaded EPS DRB.

Then the method 400 proceeds to step S403, at which the method 400 hands over, based on a handover request ACK from the target local area BS, the UE to the target local area BS for continuing with at least one of an ongoing local area service and an ongoing wide area service without changing security keys of the same wide area BS.

Although not shown, in some embodiments, the handover request ACK at least includes configuration information of the at least one local area DRB which has been accepted by the target local area BS and radio resource configuration information. In some embodiments, the handing over to the target local area BS comprises handing over to the target local area BS via an X2 interface between the source local area BS and the target local area BS.

Finally, the method 400 ends at step S404.

With the method 400 according to the embodiments of the present invention, the handover latency and service continuity during the inter-AP mobility would be efficiently improved in a secure manner since the wide area BS appears to be “bypassed” and thus its security keys are not affected when handing over the local services.

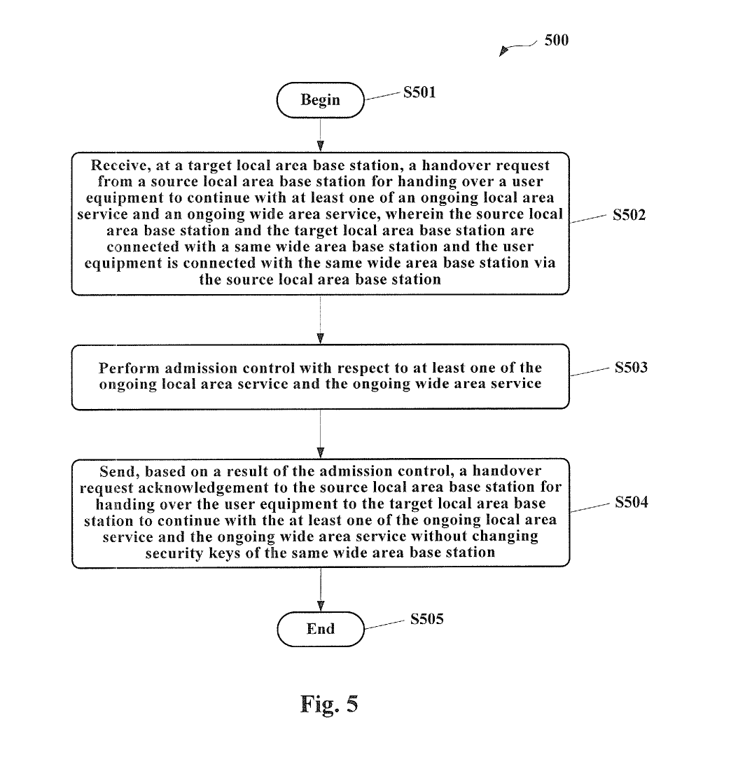

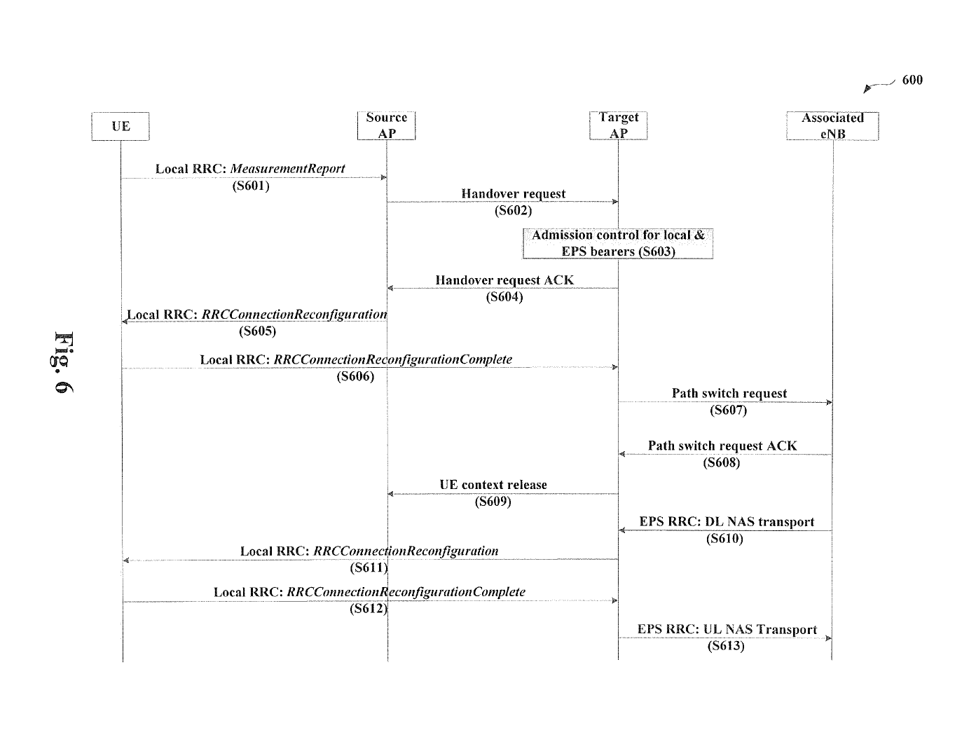

FIG. 5 is a flow chart schematically illustrating a method 500 for mobility control in a heterogeneous network from a perspective of a target local area BS (e.g., a target AP) according to one embodiment of the present invention. As illustrated in FIG. 5, the method 500 begins at step S501 and proceeds to step S502, at which the method 500 receives, at a target local area BS, a handover request from a source local area BS for handing over a UE to continue with at least one of an ongoing local area service and an ongoing wide area service, wherein the source local area BS and the target local area BS are connected with a same wide area BS and the UE is connected with the same wide area BS via the source local area BS.

Although not shown, in some embodiments, the ongoing local area service is carried by at least one local area DRB and the ongoing wide area service is carried by at least one offloaded EPS DRB. Further, in some embodiments, the handover request at least includes information regarding QoS of the at least one local area DRB, QoS of the at least one offloaded EPS DRB, and at least one local security key to be used by the target local area BS.

Then the method 500 proceeds to step S503, at which the method 500 performs admission control with respect to at least one of the ongoing local area service and the ongoing wide area service. After that, the method 500 advances to step S504, at which the method 500 sends, based on a result of the admission control, a handover request ACK to the source local area BS for handing over the UE to the target local area BS to continue with the at least one of the ongoing local area service and the ongoing wide area service without changing security keys of the same wide area BS.

Although not shown, in some embodiments, the handover request ACK at least includes configuration information of the at least one local area DRB which has been accepted by the target local area BS and radio resource configuration information. In some embodiments, the method 500 further comprises at least reporting to the same wide area BS at least one updated offloaded EPS DRB as a result of admission control with respect to at least one ongoing wide area service; forwarding to the user equipment having been connected with the target local area BS by the handover an updated configuration of at least one updated offloaded EPS DRB from the same wide area BS; and forwarding to the same wide area BS a reconfiguration complete message for the updated configuration from the UE to hand over the at least one updated offloaded EPS DRB to the target local area BS.

Finally, the method 500 ends at step S505.

It is to be understood by a person skilled in the art that the handover between the source local area BS and the target local area BS is performed via an X2 interface and communication of the source and target local area BSs with the same wide area BS is performed via an S1 interface. Similar to the method 400, due to less involvement of the associated eNB, the handover latency and service continuity can be improved. Further, because the security keys of the associated eNB are kept intact during the inter-AP handover, occurrences of the data interruption would be significantly reduced since reestablishment of the EPS PDCP entities is unnecessary

FIG. 6 is a signaling flow for a method 600 of mobility control in a heterogeneous network according to an embodiment of the present invention. As illustrated in FIG. 6, a UE is working in a single radio mode with ongoing EPS services via the associated eNB to the EPC and local services via the source AP (or target AP) to the local server. During its movement and with the lapse of time, the UE may become increasingly remote from the source AP and close to the target AP. Due to this, the UE sends, at step S601, a measurement report regarding the target AP to the source AP in which case the inter-AP mobility procedure might be triggered. Upon receipt of the measurement report regarding the target AP, the source AP may be aware that they both share the same associated eNB by e.g., checking the availability of an X2 interface within the same sub-network or using the reported target cell information if the target AP broadcasts its associated eNB's identity.

After that, the source AP issues at step S602 a handover request to the target AP to request admission for its ongoing local service bearers and offloaded EPS service bearers. According to embodiments of the present invention, the handover request message may include but is not limited to information regarding QoS of the local bearers, QoS of the EPS bearers and target local AS keys that the source AP calculates to be used in the target AP. Information regarding the EPS security keys is not required to be included in the handover request message as long as the associated eNB remains the same during the inter-AP handover. This is because the EPS RRC can be regarded or treated as a “NAS” layer for the local RRC protocol stack so that the mobility of the local RRC level does not need to update security keys at the “NAS” layer, as illustrated in the protocol stack of FIG. 2. As was noted before, keeping EPS security keys unchanged can reduce the data interruption for EPS services, wherein the data interruption might occur due to reestablishment of the EPS PDCP entities. Of course, the associated eNB can update the EPS security keys whenever it desires after the inter-AP handover is completed, which can avoid the UE to use the same EPS security keys all the time under the same associated eNB. This scheme enables good decoupling and separation between local security and EPS security mechanisms, and thus enables flexible deployment of LTE-Hi.

At step S603, the target AP performs the local and EPS bearer admission control. For example, the target AP may perform admission control based on the requested QoS requirements for local services and EPS services. For local services, the target AP will directly feed back, at step S604, a handover request ACK (i.e., a handover command) to the source AP through an X2 interface, wherein the handover request ACK includes configurations of those accepted bearers together with other radio resource configurations. The handover command herein may only carry local bearer information and use delta-signaling based on the configuration used in the source AP side.

Compared with the S1-based handover mentioned previously, this X2-based handover according to embodiments of the present invention can provide better service continuity for local services due to lower backhaul latency. For EPS services, although it is the associated eNB that generally controls the EPS bearers for the UE, the associated eNB herein is not requested for the admission control for the EPS bearers. Rather, the target AP performs EPS bearer admission control on behalf of the associated eNB via the X2 interface, which can reduce corresponding latency in the handover preparation. It should be noted that the offloaded EPS service bearer information was previously kept in the source AP as part of UE context after the associated eNB has requested and confirmed the E-RAB setup towards this source AP during an offloading process. Thus, it is needless to send configurations of all the EPS DRBs back to the source AP over the handover request ACK in case all the EPS DRBs are accepted by the target AP in the admission control.

Upon receiving the handover request ACK from the target AP, the source AP sends, at step S605, the local handover command, such as an RRCConnectionReconfiguration message, to the UE. Then, in response to the local handover command, the UE sends, at step S606, an RRCConnectionReconfigurationComplete message to the target AP, thereby completing handing over the UE to the target AP in terms of the local services.

For the EPS services, the target AP will report, at step S607, those updated DRBs, if any, to the associated eNB and information regarding those updated DRBs can be included in a path switch request message after the target AP has received the handover complete (e.g., local RRCConnectionReconfigurationComplete) message. The path switch request message herein at least includes the updated EPS DRB configurations and other configurations, such as logical channel priorities and RRC configurations. In case no EPS bearers are updated by the target AP, the associated eNB will not be notified about this in the path switch request message and there is no need to inform UE of any changes to the ongoing EPS bearers, i.e., no need for an EPS RRC reconfiguration procedure. Upon receipt of the report of the updated DRBs, the associated eNB sends, at step S608, a path switch request ACK to the target AP, which in turn instructs the source AP to release the UE context at step S609.

At step S610, the associated eNB sends in DL transport NAS messages encapsulated in ciphered NAS containers over EPS RRC to the target AP, wherein the NAS messages include updated EPS bearer configuration information ciphered by security keys of the associated eNB. The reason why the target AP cannot encapsulate this updated EPS bearer configuration in the local handover command is that this EPS domain information should be ciphered and integrity protected by EPS security keys instead of local security keys, and thus the EPS RRC should be utilized to accomplish this. The target AP then sends, at step S611, a local RRCConnectionReconfiguration message to the UE. Responsive to receipt of this local RRCConnectionReconfiguration message, the UE sends, at step S612, a local RRCConnectionReconfigurationComplete message to the target AP, which in turn sends, at step S613, in UL transport NAS messages encapsulated in ciphered NAS containers over EPS RRC to the associated eNB, wherein the NAS messages include EPS ReconfigurationComplete information ciphered by security keys of the associated eNB.

It is to be understood that the EPS bearer reconfiguration procedure as discussed above during the inter-AP handover is triggered by the target AP through the S1 interface to the associated eNB, which is notably different from the case of an initial EPS bearer configuration being initiated by the eNB. Compared with the S1-based handover in a conventional manner where the macro eNB is always involved, the EPS services also experience an X2-based handover similar to local services with shorter latency.

Further, the inter-AP mobility control as proposed by the embodiments of the present invention not only addresses the simple scenario where the LTE-Hi AP is co-located with an SN and thus inter-AP handover herein also means the inter-SN handover, but also can be easily extended to the scenario of intra SN and inter-SN mobility in case of standalone SN. For the inter-AP mobility under the same SN, it is unnecessary to send the path switch request message to the eNB and the eNB should be informed only if the inter-AP handover below the SN results in EPS bearer modifications or updates.

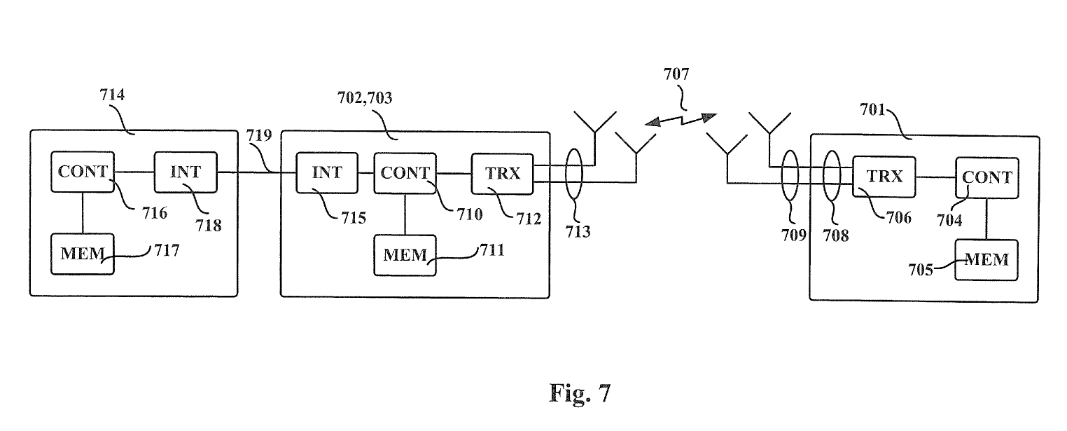

FIG. 7 is a simplified schematic block diagram illustrating apparatuses according to an embodiment of the present invention. As illustrated in FIG. 7, a UE 701 is located in the coverage of a radio network node 702 or 703 and is configured to be in connection with the radio network node 702 or 703. The UE 701 comprises a controller 704 operationally connected to a memory 705 and a transceiver 706. The controller 704 controls the operation of the UE 701. The memory 705 is configured to store software and data. The transceiver 706 is configured to set up and maintain a wireless connection 707 to the radio network node 702 or 703. The transceiver 706 is operationally connected to a set of antenna ports 708 connected to an antenna arrangement 709. The antenna arrangement 709 may comprise a set of antennas. The number of antennas may be one to four, for example. The number of antennas is not limited to any particular number. The UE 701 may also comprise various other components, such as a user interface, camera, and media player. They are not displayed in the figure due to simplicity.

The radio network node 702 or 703, such as an LTE BS (or eNB) or LTE-LAN AP included in an LTE-LAN, comprises a controller 710 operationally connected to a memory 711, and a transceiver 712. The controller 710 controls the operation of the radio network node 702 or 703. The memory 711 is configured to store software and data. The transceiver 712 is configured to set up and maintain a wireless connection to the UE 701 within the service area of the radio network node 702 or 703. The transceiver 712 is operationally connected to an antenna arrangement 713. The antenna arrangement 713 may comprise a set of antennas. The number of antennas may be two to four, for example. The number of antennas is not limited to any particular number. The radio network node 702 or 703 may be operationally connected (directly or indirectly) to another CN or LAN network element 714 of the communication system, such as an RNC, an MME, an MSC server (MSS), an MSC, an RRM node, a gateway GPRS support node, an OAM node, an HLR, a VLR, a serving GPRS support node, a GW, and/or a server, via an interface 715. The network node 714 comprises a controller 716 operationally connected to a memory 717, and an interface 718. The controller 716 controls the operation of the network node 714. The memory 717 is configured to store software and data. The interface 718 is configured to connect to the radio network node 702 or 703 via a connection 719. The embodiments are not, however, restricted to the network given above as an example, but a person skilled in the art may apply the solution to other communication networks provided with the necessary properties. For example, the connections between different network elements may be realized with IP connections.

Although the apparatus 701, 702, 703, or 714 has been depicted as one entity, different modules and memory may be implemented in one or more physical or logical entities. The apparatus may also be a user terminal which is a piece of equipment or a device that associates, or is arranged to associate, the user terminal and its user with a subscription and allows a user to interact with a communication system. The user terminal presents information to the user and allows the user to input information. In other words, the user terminal may be any terminal capable of receiving information from and/or transmitting information to the network, connectable to the network wirelessly or via a fixed connection. Examples of the user terminals include a personal computer, a game console, a laptop (a notebook), a personal digital assistant, a mobile station (mobile phone), a smart phone, a communicator, a tablet or a pad.

The apparatus 701, 702, 703, or 714 may generally include a processor, controller, control unit or the like connected to a memory and to various interfaces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of the embodiments of the present invention, such as handing over the UE to the target local area BS without changes to the security keys of the associated eNB.

The memory 705, 711, or 717 may include volatile and/or non-volatile memory and typically stores content, data, or the like. For example, the memory 705, 711, or 717 may store computer program code such as software applications (for example for handing over the UE to the target AP without affecting the security keys of the associated eNB, as discussed in detail previously) or operating systems, information, data, content, or the like for a processor to perform steps associated with operation of the apparatus 701, 702, 703 or 714 in accordance with embodiments. The memory may be, for example, a random access memory (RAM), a hard drive, or other fixed data memories or storage devices. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

Many modifications and other embodiments of the inventions set forth herein will come to mind to one skilled in the art to which these embodiments of the invention pertain having the benefit of the teachings presented in the foregoing description's and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1-27. (canceled)

28. A method, comprising:
sending, by a source local area base station, a handover request for handing over a user equipment to a target local area base station, wherein the source and target local area base stations are connected with a same wide area base station and the user equipment is connected with the same wide area base station via the source local area base station; and
handing over, based on a handover request acknowledgement from the target local area base station, the user equipment to the target local area base station for continuing with at least one of an ongoing local area service and an ongoing wide area service without changing security keys of the same wide area base station.

29. The method as recited in claim 28, further comprising:
receiving, prior to sending a handover request, a measurement report from the user equipment; and
determining, based on the measurement report, whether the target local area base station is connected with the same wide area base station.

30. The method as recited in claim 29, wherein the determining comprises at least one of checking availability of an X2 interface between the source local area base station and the target local area base station and checking target cell information included in the measurement report.

31. The method as recited in claim 28, wherein the handing over to the target local area base station comprises handing over to the target local area base station via an X2 interface between the source local area base station and the target local area base station.

32. The method as recited in claim 28, wherein the ongoing local area service is carried by at least one local area data radio bearer and the ongoing wide area service is carried by at least one offloaded enhanced packet system data radio bearer.

33. The method as recited in claim 32, wherein the handover request at least includes information regarding quality of service of the at least one local area data radio bearer, quality of service of the at least one offloaded enhanced packet system data radio bearer, and at least one local security key to be used by the target local area base station.

34. The method as recited in claim 32, wherein the handover request acknowledgement at least includes configuration information of the at least one local area data radio bearer which has been accepted by the target local area base station and radio resource configuration information.

35. The method as recited in claim 32, wherein the handover request is used to request the target local area base station for admission of one or more of the at least one local area data radio bearer and the at least one offloaded enhanced packet system data radio bearer.

36. An apparatus, comprising:
at least one processor; and
at least one memory including compute program instructions,
wherein the at least one memory and computer program instructions are configured to, with the at least one processor, cause the apparatus at least to:
send, by a source local area base station, a handover request for handing over a user equipment to a target local area base station, wherein the source and target local area base stations are connected with a same wide area base station and the user equipment is connected with the same wide area base station via the source local area base station; and
hand over, based on a handover request acknowledgement from the target local area base station, the user equipment to the target local area base station for continuing with at least one of an ongoing local area service and an ongoing wide area service without changing security keys of the same wide area base station.

37. The apparatus as recited in claim 36, wherein the ongoing local area service is carried by at least one local area data radio bearer and the ongoing wide area service is carried by at least one offloaded enhanced packet system data radio bearer.

38. The apparatus as recited in claim 36, wherein the handing over to the target local area base station comprises handing over to the target local area base station via an X2 interface between the source local area base station and the target local area base station.

39. The apparatus as recited in claim 36, wherein the at least one memory and computer program instructions are further configured to, with the at least one processor, cause the apparatus at least to:
receive, prior to sending a handover request, a measurement report from the user equipment; and
determine, based on the measurement report, whether the target local area base station is connected with the same wide area base station.

40. The apparatus as recited in claim 39, wherein the at least one memory and computer program instructions are further configured to, with the at least one processor, cause the apparatus to determine whether the target local area base station is connected with the same wide area base station, at least to perform one of the following:
check availability of an X2 interface between the source local area base station and the target local area base station; and
check target cell information included in the measurement report.

41. The apparatus as recited in claim 40, wherein the handover request at least includes information regarding quality of service of the at least one local area data radio bearer, quality of service of the at least one offloaded enhanced packet system data radio bearer, and at least one local security key to be used by the target local area base station.

42. The apparatus as recited in claim 40, wherein the handover request acknowledgement at least includes configuration information of the at least one local area data radio bearer which has been accepted by the target local area base station and radio resource configuration information.

43. The apparatus as recited in claim 40, wherein the handover request is used to request the target local area base station for admission of one or more of the at least one local area data radio bearer and the at least one offloaded enhanced packet system data radio bearer.

44. An apparatus, comprising:
at least one processor; and
at least one memory including compute program instructions,
wherein the at least one memory and computer program instructions are configured to, with the at least one processor, cause the apparatus at least to:
receive, at a target local area base station, a handover request from a source local area base station for handing over a user equipment to continue with at least one of an ongoing local area service and an ongoing wide area service, wherein the source and target local area base stations are connected with a same wide area base station and the user equipment is connected with the same wide area base station via the source local area base station;
perform admission control with respect to at least one of the ongoing local area service and the ongoing wide area service; and
send, based on a result of the admission control, a handover request acknowledgement to the source local area base station for handing over the user equipment to the target local area base station to continue with the at least one of the ongoing local area service and the ongoing wide area service without changing security keys of the same wide area base station.

45. The apparatus as recited in claim 44, wherein the ongoing local area service is carried by at least one local area data radio bearer and the ongoing wide area service is carried by at least one offloaded enhanced packet system data radio bearer.

46. The apparatus as recited in claim 44, wherein the handover request acknowledgement at least includes configuration information of the at least one local area data radio bearer which has been accepted by the target local area base station and radio resource configuration information.

47. The apparatus as recited in claim 44, wherein the at least one memory and computer program instructions are further configured to, with the at least one processor, cause the apparatus at least to:
report to the same wide area base station at least one updated offloaded enhanced packet system data radio bearer as a result of admission control with respect to at least one ongoing wide area service;
forward to the user equipment having been connected with the target local area base station by the handover an updated configuration of at least one updated offloaded enhanced packet system data radio bearer from the same wide area base station; and
forward to the same wide area base station a reconfiguration complete message for the updated configuration from the user equipment to hand over the at least one updated offloaded enhanced packet system data radio bearer to the target local area base station.
